(19) United States
(12) Patent Application Publication
(10) Pub. No.: US 2008/0232668 A1
(43) Pub. Date: Sep. 25, 2008

(54) DEVICE, METHOD AND RECORDING MEDIUM CONTAINING PROGRAM FOR SEPARATING IMAGE COMPONENT

(75) Inventors: Yoshiro KITAMURA, Ashigarakami-gun (JP); Wataru ITO, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/053,706

(22) Filed: Mar. 24, 2008

(30) Foreign Application Priority Data
Mar. 22, 2007 (JP) 074687/2007

(51) Int. Cl. G06K 9/00

(52) U.S. Cl. 382/132

(57) ABSTRACT

A technique for appropriately separating three components contained in radiographic images is disclosed. A component image generating unit separates an image component, which represents any one of a soft part component, a bone component and a heavy element component including an element having an atomic number higher than that of the bone component in a subject, from inputted three radiographic images, which represents degrees of transmission of three patterns of radiations having different energy distributions through the subject, by calculating a weighted sum for each combination of corresponding pixels between the three radiographic images using predetermined weighting factors.

### BACKGROUND OF THE INVENTION

1. Field of the Invention

The present invention relates to a device and a method for separating a specific image component in an image through the use of radiographic images taken with radiations having different energy distributions, and a recording medium containing a program for causing a computer to carry out the method.

2. Description of the Related Art

The energy subtraction technique has been known in the field of medical image processing. In this technique, two radiographic images of the same subject are taken by applying radiations having different energy distributions to the subject, and image signals representing pixels of the two radiographic images are multiplied with suitable weighting factors and subtraction between corresponding pixels of these images is carried out to obtain difference signals, which represents an image of a certain structure. Using this technique, a soft part image from which the bone component has been removed or a bone part image from which the soft part component has been removed can be generated from the inputted images. By removing parts that are not of interest in diagnosis from the image used for image interpretation, visibility of the part of interest in the image is improved (see, for example, Japanese Unexamined Patent Publication No. 2002-152593).

Further, it has been proposed to apply the energy subtraction technique to an image obtained in angiographic examination. For example, a contrast agent, which selectively accumulates at a lesion, is injected in a body through a catheter inserted in an artery, and then, two types of radiations having energy around the K absorption edge of iodine, which is a main component of the contrast agent, are applied to take X-ray images having two different energy distributions. Thereafter, the above-described energy subtraction can be carried out to separate a component representing the contrast agent and a component representing body tissues in the image (see, for example, Japanese Unexamined Patent Publication No. 2004-064637) Similarly, a metal component forming a guide wire of the catheter, which is a heavier element than the body tissue components, can also be separated by the energy subtraction.

However, the methods described in Japanese Unexamined Patent Publication Nos. 2002-152593 and 2004-064637 carry out only separation between two components using two images. For example, the method of Japanese Unexamined Patent Publication No. 2004-064637 can separate an image component representing the body tissues from an image component representing the metal and the contrast agent; however, cannot make, from its principle, further separation of the component representing the body tissues into the soft part component and the bone component.

### SUMMARY OF THE INVENTION

In view of the above-described circumstances, the present invention is directed to providing a device, a method and a recording medium containing a program for allowing more appropriate separation between three components represented in radiographic images.

The image component separating device of the invention includes a component separating means for separating an image component from inputted three radiographic images by calculating a weighted sum for each combination of corresponding pixels between the three radiographic images using predetermined weighting factors, wherein the three radiographic images are formed by radiation transmitted through a subject and represent degrees of transmission of three patterns of radiations having different energy distributions through the subject, and the image component representing any one of a soft part component, a bone component and a heavy element component including an element having an atomic number higher than that of the bone component in the subject.

The image component separating method of the invention separates an image component from inputted three radiographic images by calculating a weighted sum for each combination of corresponding pixels between the three radiographic images using predetermined weighting factors, wherein the three radiographic images are formed by radiation transmitted through a subject and represent degrees of transmission of three patterns of radiations having different energy distributions through the subject, and the image component representing any one of a soft part component, a bone component and a heavy element component including an element having an atomic number higher than that of the bone component in the subject.

The recording medium containing an image component separating program of the invention contains a program for causing a computer to carry out the above-described image component separating method.

Details of the present invention will be explained below.

The “three radiographic images (which) are formed by radiation transmitted through a subject and represent degrees of transmission of three patterns of radiations having different energy distributions through the subject” to be inputted may be obtained in a three shot method in which imaging is carried out three times using three patterns of radiations having different energy distributions, or may be obtained in a one shot method in which radiation is applied once to three storage phosphor sheets stacked one on the other via additional filters such as energy separation filters (they may be in contact to or separated from each other) so that radiations having different energy distributions are detected on the three sheets. Analog images representing the degrees of transmission of the radiation through the subject recorded on the storage phosphor sheets are converted into digital images by scanning the sheets with excitation light, such as laser light, to generate photostimulated luminescence, and photoelectrically reading the obtained photostimulated luminescence. Besides the above-described storage phosphor sheet, other means, such as a flat panel detector (FPD) employing CMOS, may be appropriately selected and used for detecting the radiation depending on the imaging method.

The “corresponding pixels between the three radiographic images” refers to pixels in the radiographic images positionally corresponding to each other with reference to a predetermined structure (such as a site to be observed or a marker) in the radiographic images. If the radiographic images have been taken in a manner that the position of the predetermined structure in the images does not shift between the images, the corresponding pixels are pixels at the same coordinates in the coordinate system in the respective images. However, if the radiographic images have been taken in a manner that the position of the predetermined structure in the images shifts between the images, the images may be aligned with each other through linear alignment using scaling, translation, rotation, or the like, non-linear alignment using warping or the like, or a combination of any of these techniques. It should be noted that the alignment between the images may be carried out using a method described in U.S. Pat. No. 6,751,341, or any other method known at the time of putting the invention into practice.

The “predetermined weighting factors” are determined according to a component to be separated; however, the determination of the predetermined weighting factors may further be based on the energy distribution information representing the energy distribution corresponding to each of the inputted three radiographic images.

The “energy distribution information” refers to information about a factor that influences the quality of radiation. Specific examples thereof include a tube voltage, the maximum value, the peak value and the mean value in the spectral distribution of the radiation, presence or absence of an additional filter such as an energy separation filter and the thickness of the filter. Such information may be inputted by the user via a predetermined user interface during the image component separation process, or may be obtained from accompanying information of each radiographic image, which may comply with the DICOM standard or a manufacturer's own standard.

Specific examples of a method for determining the weighting factors may include: referencing a table that associates possible combinations of energy distribution information of the inputted three radiographic images with weighting factors for the respective images; or determining the weighting factors by executing a program (subroutine) that implements functions for outputting the weighting factors for the respective images based on the energy distribution information of the inputted three radiographic images. The relationships between the possible combinations of the energy distribution information of the inputted three radiographic images and the weighting factors for the respective images may be found in advance through an experiment.

Further, as a method for indirectly determining the weighting factors, the following method may be used. Each radiographic image is fitted to a model that represents an exposure amount of the radiation at each pixel position in the radiographic images as a sum of attenuation amounts of the radiation at the respective components and represents the attenuation amounts at the respective components using attenuation coefficients determined for the respective components based on the energy distribution corresponding to the radiographic image and the thicknesses of the respective components. Then, the weighting factors are determined so that the attenuation amounts at the components other than the component to be separated become small enough to meet a predetermined criterion. An example of mathematical expression of the above model is shown below.

Supposing that a suffix for identifying each image is n (n=1, 2, 3), the attenuation coefficients for the respective components in each image are αₙ, βₙ, γₙ, and the thicknesses of the respective components in each image are tₛ (soft part component), t_{b} (bone component), tₕ (heavy element component), a logarithmic exposure amount Eₙ of each of the three radiographic images can be expressed as equation (1), (2), (3), respectively:

E₁=α₁·tₛ+β₁·t_{b}+γ₁·tₕ (1),

E₂=α₂·tₛ+β₂·t_{b}+γ₂·tₕ (2),

E₃=α₃·tₛ+β₃·t_{b}+γ₃·tₕ (3).

The logarithmic exposure amount Eₙ of the radiographic image is a value obtained by log-transforming an amount of radiation that has transmitted through the subject and applied to the radiation detecting means during imaging of the subject. The exposure amount can be obtained by directly detecting the radiation applied to the radiation detecting means; however, it is very difficult to detect the exposure amount at each pixel of the radiographic image. Since the pixel value of each pixel of the image obtained on the radiation detecting means is larger as the exposure amount is larger, the pixel values and the exposure amounts can be related to each other. Therefore, the exposure amounts in the above equations can be substituted with the pixel values.

Further, the attenuation coefficients αₙ, βₙ, γₙ, are influenced by quality of the radiation and components in the subject. In general, the higher the tube voltage of the radiation, the smaller the attenuation coefficient, and the higher the atomic number of the component in the subject, the larger the attenuation coefficient. Therefore, the attenuation coefficients αₙ, βₙ, γₙ are determined for the respective components in each image (each energy distribution), and can be found in advance through an experiment.

The thickness tₛ, t_{b}, tₕ of each component differs from position to position in the subject, and cannot be obtained directly from the inputted radiographic image. Therefore, the thickness is regarded as a variable in each of the above equations.

The terms on the right-hand side of each of the above equations represent the attenuation amounts of radiation at the respective components, and this means that the image expressed by each equation reflects mixed influences of the attenuation amounts of radiation at the respective components. Each of these terms is a product of the attenuation coefficient of each component in each image (each energy distribution) and the thickness of each component, and this means that the attenuation amount of radiation at each component depends on the thickness of the component. Based on this model, the process for separating one component from the other components in the image by combining weighted images of the invention means that, in order to obtain relational expressions that are independent from the thicknesses of the components other than the component to be separated, values of the coefficient parts of the terms corresponding to the components other than the component to be separated become 0 by multiplying the respective terms in each of the above equations with appropriate weighting factors and calculating a weighted sum thereof. Therefore, in order to separate a certain component in the image, it is necessary to determine the weighting factors such that the coefficient parts of the terms corresponding to the components other than the component to be separated on the right side of each equation become 0.

Supposing that weighting factors w₁, w₂ and w₃ are respectively applied to the logarithmic exposure amounts, a weighted sum of the logarithmic exposure amounts E₁, E₂ and E₃ of the respective images is expressed by equation (4) below:

w₁·E₁+w₂·E₂+w₃·E₃=(w₁·α₁+w₂·α₂+w₃·α₃)·tₛ+(w₁·β₁+w₂·β₂+w₃·β₃)·t_{b}+(w₁·γ₁+w₂·γ₂+w₃·γ₃)·tₕ (4).

Supposing that the component to be separated is the heavy element component, then, it is necessary to render the coefficients for the thicknesses tₛ and t_{b} of the other components to 0. Therefore, weighting factors w₁ₕ, w₂ₕ and w₃ₕ that simultaneously satisfy equations (5) and (6) below are found:

w₁ₕ·α₁+w₂ₕ·α₂+w₃ₕ·α₃=0 (5),

w₁ₕ·β₁+w₂ₕ·β₂+w₃ₕ·β₃=0 (6).

Based on equations (5) and (6), the weighting factors w₁ₕ, w₂ₕ and w₃ₕ can be determined to satisfy equation (7) below:

w₁ₕ:w₂ₕ:w₃ₕ=(α₂·β₃−α₃·β₂):(α₃·β₁−α₁·β₃):(α₁·β₂−α₂·β₁) (7).

Since the weighted sum w₁ₕ·E₁+w₂ₕ·E₂+w₃ₕ·E₃ of equation (4) satisfies equations (5) and (6), the resulting image depends only on the thickness tₕ of the heavy element component. In other words, the image represented by the weighted sum w₁ₕ·E₁+w₂ₕ·E₂+w₃ₕ·E₃ is an image containing only the heavy element component which is separated from the soft part component and the bone component.

Similarly, with respect to weighting factors w₁ₛ, w₂ₛ, w₃ₛ used for separating the soft part component and weighting factor w_{1b}, w_{2b}, w_{3b} used for separating the bone component, ratios of the weighting factors that render the coefficients for the thicknesses of the components other than the component to be separated to 0 in the above equation (4) are found as equations (8) and (9) below:

w₁ₛ:w₂ₛ:w₃ₛ=(β₂·γ₃−β₃·γ₂):(β₃·γ₁−β₁·γ₃):(β₁·γ₂−β₂·γ₁) (8),

w_{1b}:w_{2b}:w_{3b}=(γ₂·α₃−γ₃·α₂):(γ₃·α₁−γ₁·α₃):(γ₁·α₂−γ₂·α₁) (9).

It should be noted that, besides the model expressed by the above equations (1), (2) and (3), a model representing the logarithmic exposure amount with reference to E₀ of the radiation applied to the subject can be expressed as equation (10) below, and the weighting factors in this case can be determined in the similar manner as that described above.

Eₙ=E₀−(αₙ′·tₛ+βₙ′·t_{b}+γₙ′·tₕ) (10)

In this equation, αₙ′, βₙ′ and γₙ′ are attenuation coefficients. Supposing that Eₙ′=E₀−Eₙ in equation (10), equation (10) can be expressed as equation (10)′ below, and this is equivalent to the above equations (1), (2) and (3).

Eₙ′=αₙ′·tₛ+βₙ′·t_{b}+γₙ′·tₕ (10)′

Specific examples of a method for determining the attenuation coefficients may include determining the attenuation coefficients by referencing a table associating the attenuation coefficients of the soft part, bone and heavy element components with energy distribution information of the inputted radiographic images, or by executing a program (subroutine) that implements functions to output the attenuation coefficients of the respective components for the inputted energy distribution information of the inputted radiographic images. The table can be created, for example, by registering possible combinations of the tube voltage of radiation and values of the attenuation coefficients of the respective components, which have been obtained through an experiment. The functions can be obtained by approximating the combinations of the above values obtained through an experiment with appropriate curves or the like. The content of the energy distribution information representing the energy distribution corresponding to each of the inputted three radiographic images and the method for obtaining the energy distribution information are as described above.

Further, in images obtained in the actual practice, a phenomenon called beam hardening may occur, in which, if the radiation applied to the subject is not monochromatic and distributes over a certain energy range, the energy distribution of the applied radiation varies depending on the thicknesses of components in the subject, and therefore the attenuation coefficient of each component varies from pixel to pixel. More specifically, an attenuation coefficient of a certain component monotonically decreases as the thicknesses of the other components increase. However, it is not possible to directly obtain thickness information of each component from the inputted radiographic image. Therefore, based on a parameter having a relationship with the thicknesses of the components, the attenuation coefficient of each component may be corrected for each pixel such that the attenuation coefficient of a certain component monotonically decreases as the thicknesses of the other components increase, to determine final attenuation coefficients for each pixel.

Alternatively, final weighting factors may be determined by correcting the above-described weighting factors for each pixel based on the above parameter.

This parameter is obtained from at least one of the inputted three radiographic images, and specific examples thereof include a logarithmic value of an amount of radiation at each pixel of one of the inputted three radiographic images, as well as a difference between logarithmic values of amounts of radiation in each combination of corresponding pixels at two of the three radiographic images, and a logarithmic value of a ratio of the amounts of radiation at each combination of the corresponding pixels, as described in the above-mentioned Japanese Unexamined Patent Publication No. 2002-152593. It should be noted that the logarithmic values of amounts of radiation can be replaced with pixel values of each image, as described above.

As a specific method for correcting the attenuation coefficients or the weighting factors using the above parameter, relationships between values of the parameter and correction amounts for the attenuation coefficients or the weighting factors may be found in advance through an experiment, and data representing the obtained relationships may be registered in a table, so that the attenuation coefficients or the weighting factors obtained for the respective components in the respective images (the respective energy distributions) can be corrected according to the correction amounts obtained by referencing the table. Alternatively, relationships between final values of the attenuation coefficients or the weighting factors and possible combinations of the energy distribution, each component in the image and each value of the above parameter may be registered in a table, so that final attenuation coefficients or final weighting factors can be directly obtained from the table without further correcting the values. Further alternatively, the attenuation coefficients or the weighting factors may be corrected or determined by executing a program (subroutine) that implements functions representing such relationships.

It should be noted that, although the weighting factors are determined so that the attenuation amounts at the components other than the component to be separated are rendered to 0 in the above-described specific example of the model, “the weighting factors are determined so that the attenuation amounts at the components other than the component to be separated become small enough to meet a predetermined criterion” described above may refer, for example, to determining the weighting factors so that the attenuation amounts become smaller than a predetermined threshold, or determining the weighting factors so that the attenuation amounts at the determined attenuation coefficients are minimized (not necessarily to be 0).

The “soft part component” refers to components of connective tissues other than bone tissues (bone component) of a living body, and includes fibrous tissues, adipose tissues, blood vessels, striated muscles, smooth muscles, peripheral nerve tissues (nerve ganglions and nerve fibers), and the like.

Specific examples of the “heavy element component” include a metal forming a guide wire of a catheter, a contrast agent, and the like.

Although the invention features that at least one of the three components is separated, two or all of the three components may be separated.

In the invention, a component image representing a component separated through the above-described image component separation process and another image representing the same subject as the subject contained in the inputted images may be combined by calculating a weighted sum for each combination of the corresponding pixels between these images using predetermined weighting factors.

The other image may be one of the inputted radiographic images, an image representing a component different from the component in the image to be combined, or an image taken with another imaging modality. Alignment between the images to be combined may be carried out before combining the images, as necessary.

Before combining the images, the color of the separated component (for example, the heavy element component) in the component image may be converted into a different color from the color of the other image.

Further, since each component distributes over the entire subject, most of the pixels of the component image have pixel values other than 0. Therefore, most of the pixels of an image obtained through the above-described image composition are influenced by the component image. For example, if the above-described color conversion is carried out before the image composition, the entire composite image is influenced by the color of the component. Therefore, gray-scale conversion may be carried out so that the value of 0 is assigned to the pixels of the component image having pixel values smaller than a predetermined threshold, and the converted component image may be combined with the other image.

### BRIEF DESCRIPTION OF THE DRAWINGS

FIG. 1 is a schematic structural diagram illustrating a medical information system incorporating an image component separating device according to embodiments of the present invention,

FIG. 2 is a block diagram illustrating the schematic configuration of the image component separating device and peripheral elements according to a first embodiment of the invention,

FIG. 3 illustrates one example of a weighting factor table according to the first embodiment of the invention,

FIG. 4 is a flow chart of an image component separation process and relating operations according to the first embodiment of the invention,

FIG. 5 is a schematic diagram illustrating images that may be generated in the image component separation process according to the first embodiment of the invention,

FIG. 6 illustrates one example of a weighting factor table according to a second embodiment of the invention,

FIG. 7 is a block diagram illustrating the schematic configuration of an image component separating device and peripheral elements according to a third embodiment of the invention,

FIG. 8 is a graph illustrating one example of relationships between energy distribution of radiation used for taking a radiographic image and attenuation coefficients of respective image components,

FIG. 9 illustrates one example of an attenuation coefficient table according to the third embodiment of the invention,

FIG. 10 is a flow chart of an image component separation process and relating operations according to the third embodiment of the invention,

FIG. 11 is a graph illustrating one example of a relationship between a parameter having a particular relationship with thicknesses of respective components in an image and an attenuation coefficient,

FIG. 12 is a block diagram illustrating the schematic configuration of an image component separating device and peripheral elements according to a fifth embodiment of the invention,

FIG. 13 is a flow chart of an image component separation process and relating operations according to the fifth embodiment of the invention,

FIG. 14 is a schematic diagram illustrating an image that may be generated when an inputted image and a heavy element image are combined in the image component separation process according to the fifth embodiment of the invention,

FIG. 15 is a schematic diagram illustrating an image that may be generated when a soft part image and the heavy element image are combined in the image component separation process according to the fifth embodiment of the invention,

FIG. 16 is a schematic diagram illustrating an image that may be generated when the heavy element image and another image are combined in the image component separation process according to the fifth embodiment of the invention,

FIG. 17 is a schematic diagram illustrating an image that may be generated when an inputted image and the heavy element image subjected to color conversion are combined in a modification of the image component separation process according to the fifth embodiment of the invention,

FIGS. 18A and 18B illustrate gray-scale conversion used in another modification of the fifth embodiment of the invention, and

FIG. 19 is a schematic diagram illustrating an image that may be generated when an inputted image and the heavy element image subjected to gray-scale conversion are combined in yet another modification of the image component separation process according to the fifth embodiment of the invention.

### DESCRIPTION OF THE PREFERRED EMBODIMENTS

Hereinafter, embodiments of the present invention will be described with reference to the drawings.

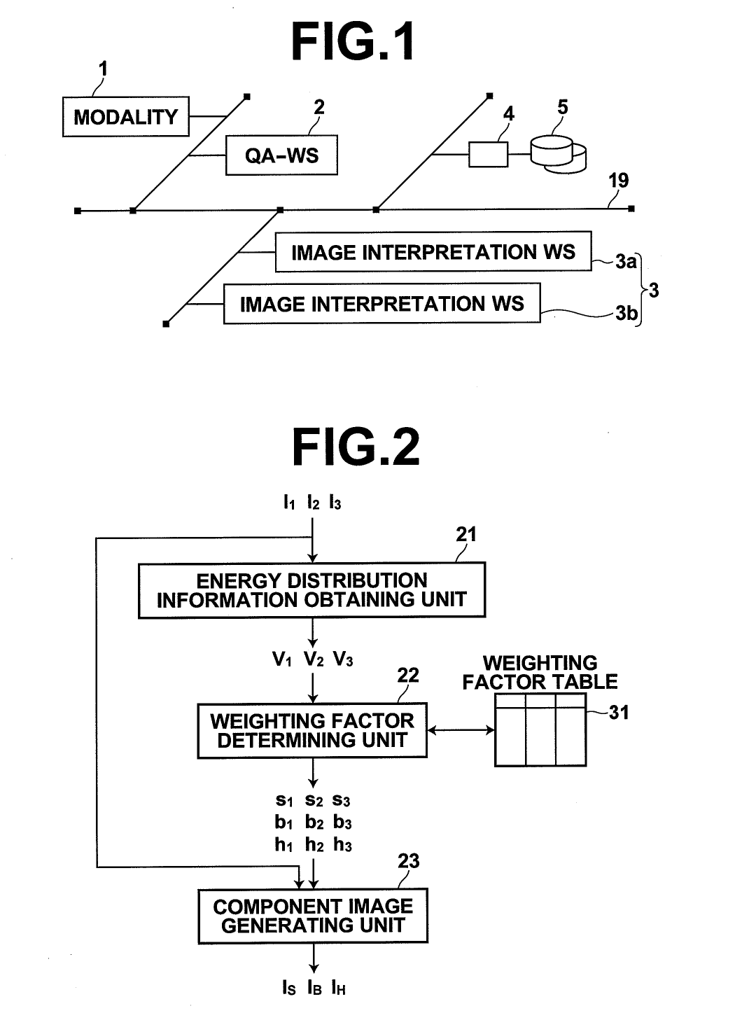

FIG. 1 illustrates the schematic configuration of a medical information system incorporating an image component separating device according to embodiments of the invention. As shown in the drawing, the system includes an imaging apparatus (modality) 1 for taking medical images, an image quality assessment workstation (QA-WS) 2, an image interpretation workstation 3 (3a, 3b), an image information management server 4 and an image information database 5, which are connected via a network 19 so that they can communicate with each other. These devices in the system other than the database are controlled by a program that has been installed from a recording medium such as a CD-ROM. Alternatively, the program may be downloaded from a server connected via a network, such as the Internet, before being installed.

The modality 1 includes a device that takes images of a site to be examined of a subject to generate image data of the images representing the site, and adds the image data with accompanying information defined by DICOM standard to output the information as the image information. The accompanying information may be defined by a manufacturer's (such as the manufacturer of the modality) own standard. In this embodiment, image information of the images taken with an X-ray apparatus and converted into digital image data by a CR device is used. The X-ray apparatus records radiographic image information of the subject on a storage phosphor sheet IP having a sheet-like storage phosphor layer. The CR device scans the storage phosphor sheet IP carrying the image recorded by the X-ray apparatus with excitation light, such as laser light, to cause photostimulated luminescence, and photoelectrically reads the obtained photostimulated luminescent light to obtain analog image signals. Then, the analog image signals are subjected to logarithmic conversion and digitalized to generate digital image data. Other specific examples of the modality include CT (Computed Tomography), MRI (Magnetic Resonance Imaging), PET (Positron Emission Tomography), and ultrasonic imaging apparatuses. Further, an image of a selectively accumulated contrast agent is also taken with the X-ray apparatus, or the like. It should be noted that, in the following description, a set of the image data representing the subject and the accompanying information thereof is referred to as the “image information”. That is, the “image information” includes text information relating to the image.

The QA-WS2 is formed by a general-purpose processing unit (computer), one or two high-definition displays and an input device such as a keyboard and a mouse. The processing unit has a software installed therein for assisting operations by the medical technologist. Through functions implemented by execution of the software program, the QA-WS2 receives the image information compliant to DICOM from the modality 1, and applies a standardizing process (EDR process) and processes for adjusting image quality to the received image information. Then, the QA-WS2 displays the image data and contents of the accompanying information contained in the processed image information on a display screen and prompts the medical technologist to check them. Thereafter, the QA-WS2 transfers the image information checked by the medical technologist to the image information management server 4 via the network 19, and requests registration of the image information in the image information database 5.

The image interpretation workstation 3 is used by the imaging diagnostician for interpreting the image and creating an image interpretation report. The image interpretation workstation 3 is formed by a processing unit, one or two high-definition display monitors and an input device such as a keyboard and a mouse. In the image interpretation workstation 3, operations such as request for viewing an image to the image information management server 4, various image processing on the image received from the image information management server 4, displaying the image, automatic detection and highlighting or enhancement of an area likely to be a lesion in the image, assistance to creation of the image interpretation report, request for registering the image interpretation report in an image interpretation report server (not shown) and request for viewing the report, and displaying the image interpretation report received from the image interpretation report server are carried out. The image component separating device of the invention is implemented on the image interpretation workstation 3. It should be noted that the image component separation process of the invention, and various other image processing, image quality and visibility improving processes such as automatic detection and highlighting or enhancement of a lesion candidate and image analysis may not be carried out on the image interpretation workstation 3, and these operations may be carried out on a separate image processing server (not shown) connected to the network 19, in response to a request from the image interpretation workstation 3.

The image information management server 4 has a software program installed thereon, which implements a function of a database management system (DBMS) on a general-purpose computer having a relatively high processing capacity. The image information management server 4 includes a large capacity storage forming the image information database 5. The storage may be a large-capacity hard disk device connected to the image information management server 4 via the data bus, or may be a disk device connected to a NAS (Network Attached Storage) or a SAN (Storage Area Network) connected to the network 19.

The image information database 5 stores the image data representing the subject image and the accompanying information registered therein. The accompanying information may include, for example, an image ID for identifying each image, a patient ID for identifying the subject, an examination ID for identifying the examination session, a unique ID (UID) allocated for each image information, examination date and time when the image information was generated, the type of the modality used in the examination for obtaining the image information, patient information such as the name, the age and the sex of the patient, the examined site (imaged site), imaging information (imaging conditions such as a tube voltage, configuration of a storage phosphor sheet and an additional filter, imaging protocol, imaging sequence, imaging technique, whether a contrast agent was used or not, lapsed time after injection of the agent, the type of the dye, radionuclide and radiation dose), and a serial number or collection number of the image in a case where more than one images were taken in a single examination. The image information may be managed in a form, for example, of XML or SGML data.

When the image information management server 4 has received a request for registering the image information from the QA-WS2, the image information management server 4 converts the image information into a database format and registers the information in the image information database 5.

Further, when the image management server 4 has received a viewing request from the image interpretation workstation 3 via the network 19, the image management server 4 searches the records of image information registered in the image information database 5 and sends the extracted image information to the image interpretation workstation 3 which has sent the request.

As the user such as the imaging diagnostician requests for viewing an image for interpretation, the image interpretation workstation 3 sends the viewing request to the image management server 8 and obtains image information necessary for the image interpretation. Then, the image information is displayed on the monitor screen and an operation such as automatic detection of a lesion is carried out in response to a request from the imaging diagnostician.

The network 19 is a local area network connecting various devices within a hospital. If, however, another image interpretation workstation 3 is provided at another hospital or clinic, the network 19 may include local area networks of these hospitals connected via the Internet or a dedicated line. In either case, the network 9 is desirably a network, such as an optical network, that can achieve high-speed transfer of the image information.

Now, functions of the image component separating device and peripheral elements according to one embodiment of the invention are described in detail. FIG. 2 is a block diagram schematically illustrating the configuration and data flow of the image component separating device. As shown in the drawing, the image component separating device includes an energy distribution information obtaining unit 21, a weighting factor determining unit 22, a component image generating unit 23 and a weighting factor table 31.

The energy distribution information obtaining unit 21 analyzes the accompanying information of the image data of the inputted radiographic images to obtain energy distribution information of radiation used for forming the images. Specific examples of the energy distribution information may include a tube voltage (peak kilovolt output) of the X-ray apparatus, the type of the storage phosphor plate, the type of the storage phosphor, and the type of the additional filter. It should be noted that, in the following description, inputted radiographic images I₁, I₂, I₃ are front chest images obtained in a three shot method in which imaging is carried out three times using three patterns of radiations having different tube voltages, and these tube voltages are used as the energy distribution information.

The weighting factor determining unit 22 references the weighting factor table 31 with values of the energy distribution information (tube voltages) of the inputted three radiographic images sorted in the ascending order (in the order of a low voltage, a medium voltage and a high voltage) used as the search key, and obtains, for each of the three radiographic images, a weighting factor for each component to be separated (soft parts, bones, heavy elements) associated with the energy distribution information used as the search key.

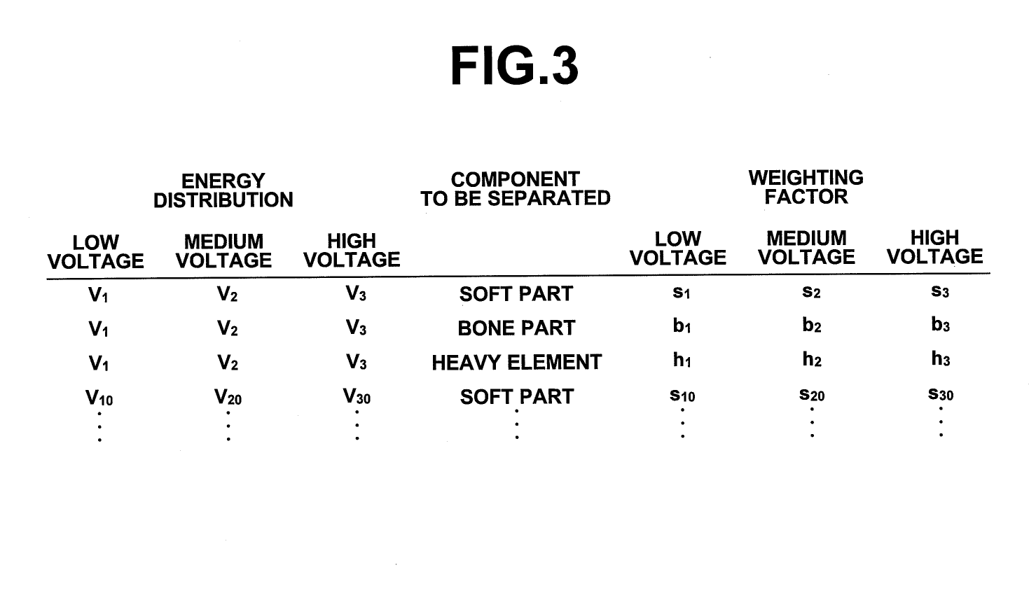

As shown in FIG. 3 as an example, the weighting factor table 31 associates the weighting factors for the three radiographic images (in the order of the low voltage, the medium voltage and the high voltage) with combinations of components to be separated and the energy distribution information of the three radiographic images (in the order of the low voltage, the medium voltage and the high voltage). Registration of the values in this table is carried out based on resulting data of an experiment which has been conducted in advance. It should be noted that, when the weighting factor determining unit 22 searches the weighting factor table 31, only a weighting factor associated with the perfect match energy distribution information (the tube voltage) may be determined as meeting the search condition, or one associated with the energy distribution information that may differ from the search key but the difference is smaller than a predetermined threshold may be determined as meeting the search condition.

The component image generating unit 23 generates each of three component images representing the respective components by calculating a weighted sum of each combination of corresponding pixels between the inputted three radiographic images, using the weighting factors for the inputted three radiographic images associated with each component. The corresponding pixels between the images may be identified by detecting a structure, such as a marker or a rib cage, in the images and aligning the images with each other based on the detected structure through a known linear or nonlinear transformation. Alternatively, the three images may be taken with an X-ray apparatus having an indicator for indicating a timing for breathing by the subject (see, for example, Japanese Unexamined Patent Publication No. 2005-012248) so that the three images are taken at the same phase of breathing. In this case, the corresponding pixels can simply be those at the same coordinates in the three images, without need of alignment between the images.

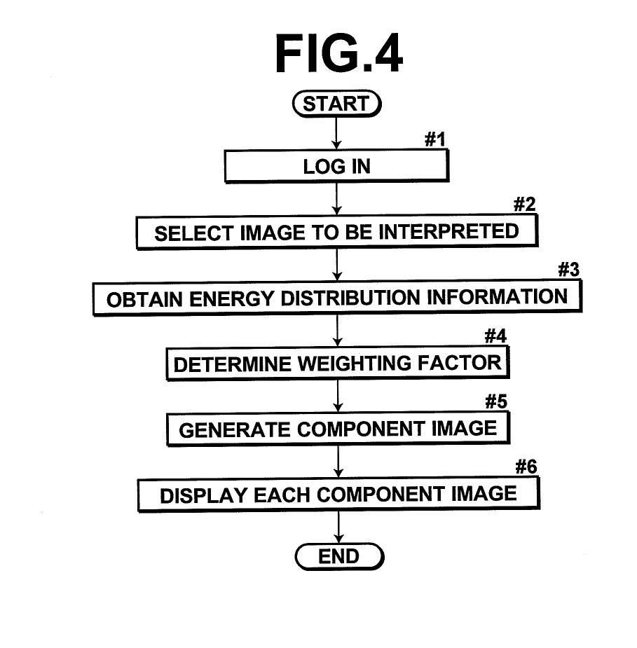

Now, workflow and data flow of the image interpretation using an image component separation process of the invention will be described with reference to the flow chart shown in FIG. 4, the block diagram shown in FIG. 2, and the example of the weighting factor table 31 shown in FIG. 3.

First, the imaging diagnostician carries out user authentication with a user ID, a password and/or biometric information such as a finger print on the image interpretation workstation 3 for gaining access to the medical information system (#1).

If the user authentication is successful, a list of images to be examined (interpreted) based on an imaging diagnosis order issued by an ordering system is displayed on the display monitor. Then, the imaging diagnostician selects an examination (imaging diagnosis) session containing the images to be interpreted I₁, I₂ and I₃ from the list of images to be examined through the use of the input device such as a mouse. The image interpretation workstation 3 sends a viewing request with image IDs of the selected images I₁, I₂ and I₃ as the search key to the image information management server 4. Receiving this request, the image information management server 4 searches the image information database 5 and obtains image files (designated by the same symbol I as the images for convenience) of the images to be interpreted I₁, I₂ and I₃, and sends the image files I₁, I₂ and I₃ to the image interpretation workstation 3 that has sent the request. The image interpretation workstation 3 receives the image files I₁, I₂ and I₃ (#2).

Then, the image interpretation workstation 3 analyzes the content of the imaging diagnosis order, and starts a process for generating component images Iₛ, I_{b}, Iₕ of soft part component, bone component and heavy element component separated from the received images I₁, I₂ and I₃, i.e., a program for causing the image interpretation workstation 3 to function as the image component separating device according to the invention.

The energy distribution information obtaining unit 21 analyzes the accompanying information of the image files I₁, I₂ and I₃ to obtain tube voltages V₁, V₂ and V₃ of the respective images (#3). In this embodiment, a relationship between the tube voltage values is: V₁<V₂<V₃.

The weighting factor determining unit 22 references the weighting factor table 31 with the obtained tube voltage values V₁, V₂, V₃ sorted in the ascending order used as the search key, and obtains and determines weighting factors for the respective images associated with each component to be separated (#4). With reference to the weighting factor table 31 in this embodiment shown in FIG. 3, weighting factors for the image I₁ with the tube voltage V₁, the image I₂ with the tube voltage V₂ and the image I₃ with the tube voltage V₃ are, respectively, s₁, s₂ and s₃ if the component to be separated is the soft parts, b₁, b₂ and b₃ if the component to be separated is the bones, and h₁, h₂ and h₃ if the component to be separated is the heavy elements.

The component image generating unit 23 generates the soft part image Iₛ, the bone part image I_{b} and the heavy element image Iₕ by calculating a weighted sum of each combination of corresponding pixels between the images for each component image to be generated using the weighting factors obtained by the weighting factor determining unit 22 (#5). The generated component images Iₛ, I_{b}, Iₕ are displayed on the display monitor of the image interpretation workstation 3 for image interpretation by the imaging diagnostician (#6).

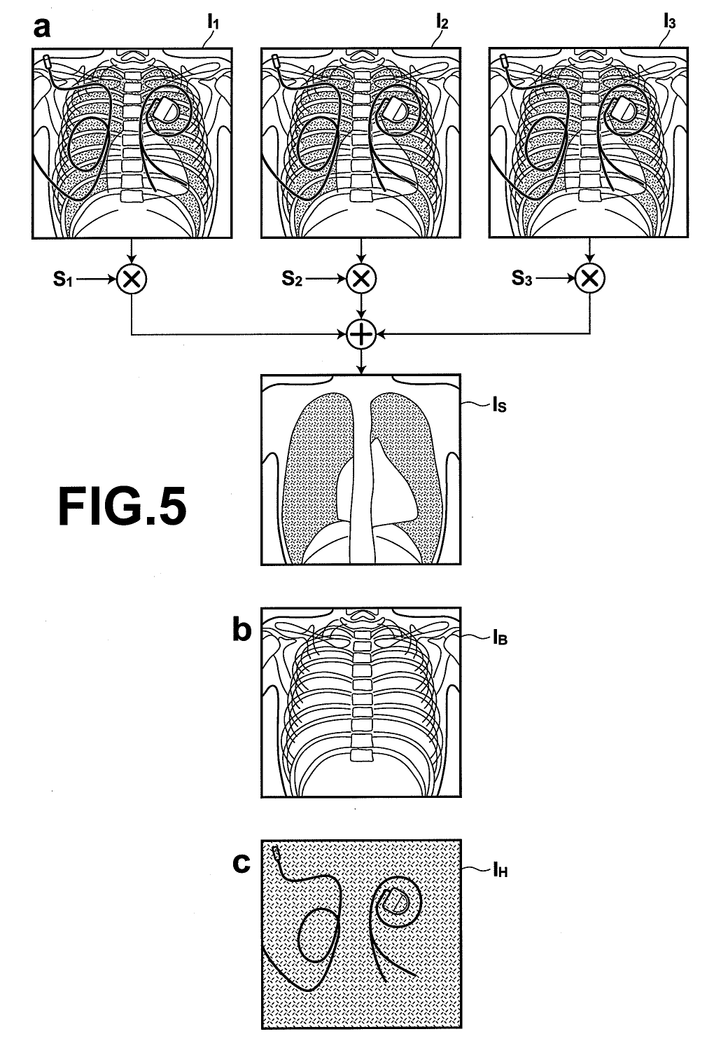

FIG. 5 schematically shows the images generated through the above process. First, as shown at “a” in FIG. 5, the soft part image Iₛ, from which the bone component and the heavy element component have been removed, is generated by calculating a weighted sum expressed by s₁·I₁+s₂·I₂+s₃·I₃ for each combination of corresponding pixels between the inputted images I₁, I₂ and I₃ containing the soft part component, the bone component and the heavy element component, such as a guide wire of a catheter or a pace maker. Similarly, the bone part image I_{b} (at “b” in FIG. 5), from which the soft part component and the heavy element component have been removed, is generated by calculating a weighted sum expressed by b₁·I₁+b₂·I₂+b₃·I₃ for each combination of corresponding pixels. Further, the heavy element image Iₕ (at “c” in FIG. 5), from which the soft part component and the bone component have been removed, is generated by calculating a weighted sum expressed by h₁·I₁+h₂·I₂+h₃·I₃ for each combination of corresponding pixels.

In this manner, in the medical information system including the image component separating device according to the embodiment of the invention, the component image generating unit 23 generates each of the component images Iₛ, I_{b}, Iₕ of the soft part component, the bone component and the heavy element component in the subject by calculating a weighted sum for each combination of corresponding pixels between the inputted three radiographic images Iₙ (n=1, 2, 3), which represent degrees of transmission of the three patterns of radiations having different energy distributions (tube voltages) through the subject, using the weighting factors sₙ, bₙ, hₙ. Therefore, the three components can appropriately be separated and visibility of each of the component images Iₛ, I_{b}, Iₕ displayed on the image interpretation workstation 3 is improved when compared to the conventional techniques in which two images are inputted.

Further, the energy distribution information obtaining unit 21 obtains the energy distribution information Vₙ representing the tube voltage of the radiation corresponding to each of the three inputted images Iₙ, and the weighting factor determining unit 22 determines the weighting factors sₙ, bₙ, hₙ for the respective image components to be separated based on the obtained energy distribution information Vₙ. Therefore, appropriate weighting factors are obtained according to the energy distribution information of the radiations used for taking the respective inputted images, thereby achieving more appropriate separation between the components.

In the above-described embodiment, the same weighting factor sₙ, bₙ or hₙ is used throughout each image, and therefore, a phenomenon called “beam hardening” may occur, where the energy distribution of the applied radiation changes depending on the thicknesses of the components in the subject, and the components cannot perfectly be separated from each other. Although it is not possible to directly find the thicknesses of the respective components, it is known that there is a particular relationship between the thicknesses of the components and the log-transformed exposure amounts of each inputted image. Since pixel values of each image are obtained by digital conversion of the log-transformed exposure amounts, there is a particular relationship between the pixel values of each image and the thicknesses of the components.

Therefore, in a second embodiment of the invention, a pixel value of each pixel of one of the inputted three radiographic images are used as a parameter, and the above-described weighting factors are determined for each pixel based on this parameter. Specifically, assuming that a pixel value of a pixel p in each inputted image Iₙ of each combination of the corresponding pixels is Iₙ (p) and the image containing the parameter pixels is I₁, weighting factors for the respective components to be separated for each pixel are expressed as sₙ(I₁(p)), bₙ(I₁(p)) and hₙ(I₁(p)), respectively. Using these expressions, a pixel value Iₛ(p), I_{b}(p) or Iₕ(p) for each pixel p in each component image is expressed as the following equation (11), (12), (13):

Iₛ(p)=s₁(I₁(p))·I₁(p)+s₂(I₁(p))·I₂(p)+s₃(I₁(p))·I₃(p) (11),

I_{b}(p)=b₁(I₁(p))·b₁(p)+b₂(I₁(p))·I₂(p)+b₃(I₁(p))·I₃(p) (12),

Iₕ(p)=h₁(I₁(p))·I₁(p)+h₂(I₁(p))·I₂(p)+h₃(I₁(p))·I₃(p) (13).

It should be noted that the image of the parameter pixels may be I₂ or I₃, and/or a difference between pixel values of corresponding pixels of two of the three inputted images may be used as the parameter (see Japanese Unexamined Patent Publication No. 2002-152593).

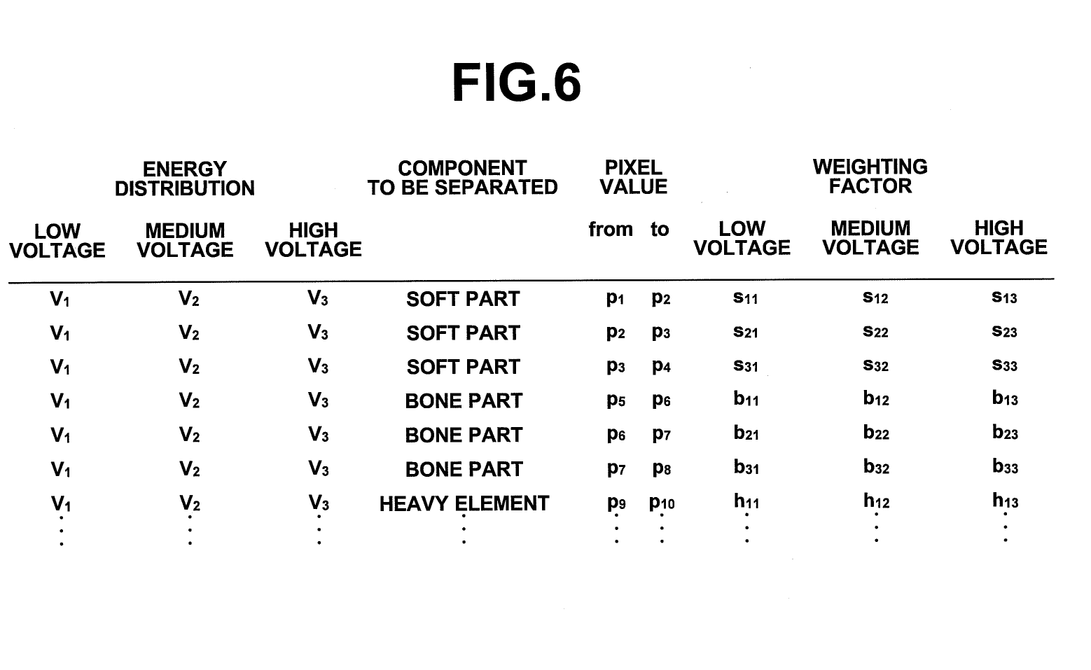

An example of implementation of these equations is described below. First, as shown in FIG. 6, an item (“pixel value from/to”) indicating ranges of pixel values of the parameter image I₁ is added to the weighting factor table 31 in the first embodiment, so that a weighting factor for each pixel of each image can be set for each energy distribution information of the image, for each component to be separated and for each pixel value range of the pixel in the image I₁ of the corresponding pixels. In the example shown in FIG. 6, assuming that the energy distribution information, i.e., the tube voltages of the three inputted images are V₁, V₂ and V₃, and the component to be separated is the soft part component, the weighting factors for the respective inputted images are: s₁₁, s₁₂ and s₁₃ if the pixel value of the image I₁ is equal to or more than p₁ and less than p₂; s₂₁, s₂₂ and s₂₃ if the pixel value of the image I₁ is equal to or more than p₂ and less than p₃; and s₃₁, s₃₂ and s₃₃ if the pixel value of the image I₁ is equal to or more than p₃ and less than p₄. It should be noted that registration of the values in this table is carried out based on resulting data of an experiment which has been conducted in advance.

Along with the addition of the above-described item to the weighting factor table 31, the weighting factor determining unit 22 references the weighting factor table 31, for each combination of corresponding pixels of the three inputted images I₁, I₂ and I₃, with the energy distribution information of each image, each component to be separated, and the pixel value of the pixel in the image I₁ used as the search key, to obtain a weighting factor for each pixel in each image.

As described above, in the second embodiment of the invention, pixel values of the image I₁ are used as the parameter having a particular relationship with the thickness of each component to be separated, and the weighting factor determining unit 22 determines a weighting factor for each pixel based on this parameter. Therefore, a factor reflecting the thickness of each component can be set for each pixel, thereby reducing the influence of the beam hardening phenomenon and achieving more appropriate separation between the components.

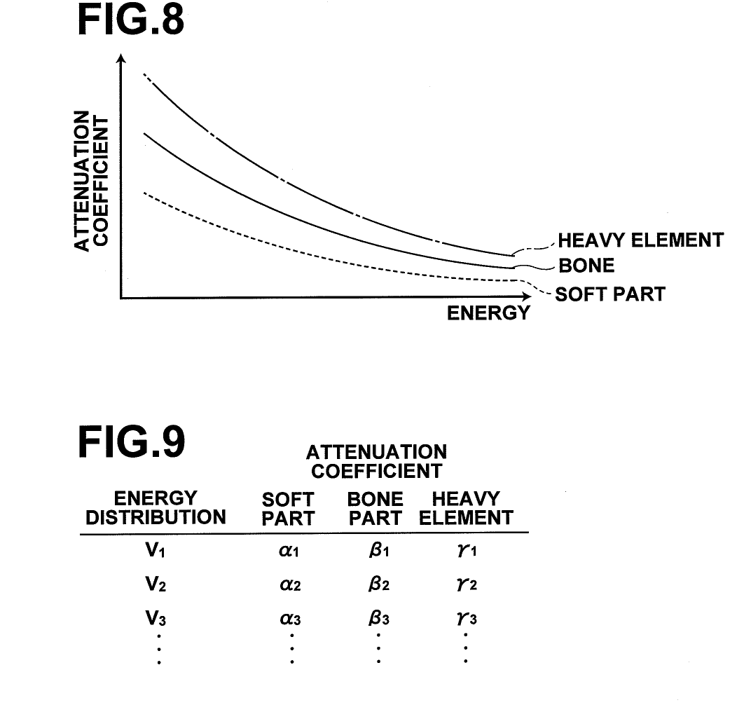

Next, a third embodiment of the invention will be described, in which the weighting factors are indirectly obtained. In this embodiment, a model using attenuation coefficients for the respective components in the above equations (1), (2) and (3) is used. As shown in FIG. 8, the attenuation coefficient monotonically decreases as the energy distribution (tube voltage) of the radiation for each image increases, and increases as the atomic number of the component increases.

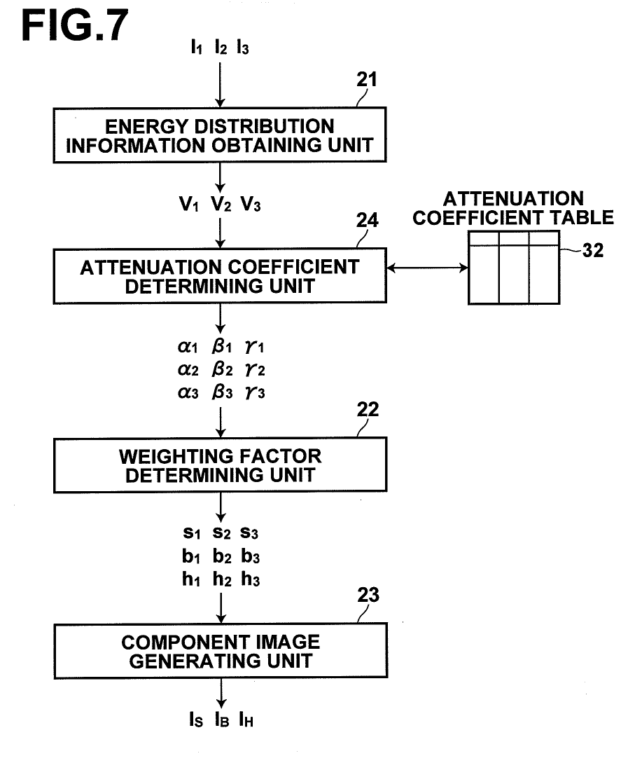

FIG. 7 is a block diagram schematically illustrating the functional configuration and data flow of the image component separating device of this embodiment. As shown in the drawing, the difference between this embodiment and the first and second embodiments lies in that an attenuation coefficient determining unit 24 is added and the weighting factor table 31 is replaced with an attenuation coefficient table 32.

The attenuation coefficient determining unit 24 references the attenuation coefficient table 32 with the energy distribution information (tube voltage) of each of the inputted three radiographic images used as the search key to obtain attenuation coefficients for the respective components to be separated (the soft part, the bone and the heavy element) associated with the energy distribution information used as the search key.

In an example shown in FIG. 9, the attenuation coefficient table 32 associates attenuation coefficients for the respective components with each energy distribution information value of the radiation for the inputted image. Registration of the values in this table is carried out based on resulting data of an experiment which has been conducted in advance. It should be noted that, when the attenuation coefficient determining unit 24 searches the attenuation coefficient table 32, only an attenuation coefficient associated with the perfect match energy distribution information (the tube voltage) may be determined as meeting the search condition, or one associated with the energy distribution information that may differ from the search key but the difference is smaller than a predetermined threshold may be determined as meeting the search condition.

The weighting factor determining unit 22 determines the weighting factors so that the above-described equations (7), (8) or (9) is satisfied, based on the attenuation coefficients for the respective components in each of the inputted three radiographic images.

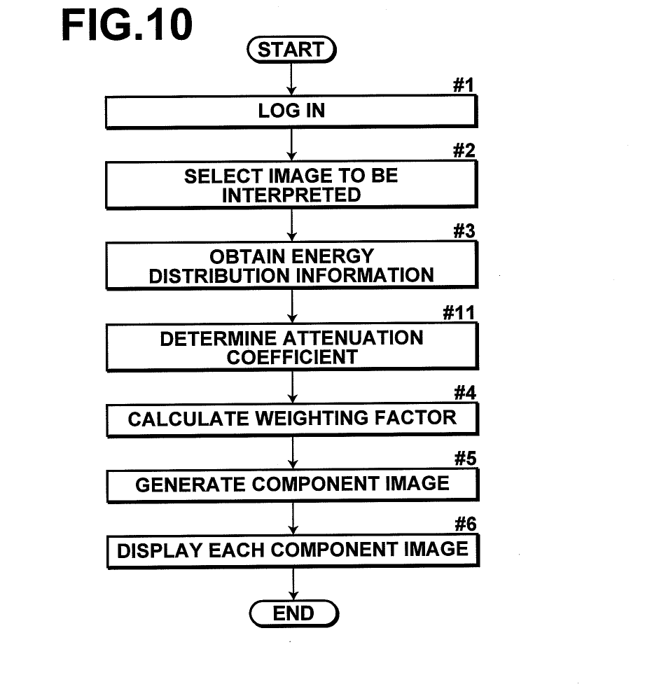

FIG. 10 is a flow chart illustrating the workflow of the image interpretation including the image separation process of this embodiment. As shown in the drawing, a step for determining the attenuation coefficients is added after step #3 of the flow chart shown in FIG. 4.

Similarly to the first embodiment, the imaging diagnostician logs in the system (#1) and selects images to be interpreted (#2). With this operation, the program for implementing the image component separating device on the image interpretation workstation 3 is started, and the energy distribution information obtaining unit 21 obtains the tube voltages V₁, V₂ and V₃ of the images to be interpreted I₁, I₂ and I₃ (#3).

Subsequently, the attenuation coefficient determining unit 24 reference the attenuation coefficient table 32 with each of the obtained tube voltage values V₁, V₂ and V₃ used as the search key to obtain and determine an attenuation coefficient for each component to be separated in each image corresponding to the tube voltage (#11). In the case of the attenuation coefficient table shown in FIG. 9, an attenuation coefficient for the soft part component in the image Iₙ with the tube voltage Vₙ is αₙ, an attenuation coefficient for the bone component is βₙ, and an attenuation coefficient for the heavy element component is γₙ (n=1, 2, 3).

Then, the weighting factor determining unit 22 assigns the attenuation coefficients αₙ, βₙ, γₙ obtained by the attenuation coefficient determining unit 24 to the above-described equations (7), (8) and (9) and calculates the weighting factors sₙ, bₙ and hₙ for the respective components to be separated in each inputted image Iₙ (#4).

Thereafter, similarly to the first embodiment, the component image generating unit 23 generates the soft part image Iₛ, the bone part image I_{b} and the heavy element image Iₕ (#5), and the images are displayed on the display monitor of the image interpretation workstation 3 (#6).

As described above, in the third embodiment of the invention, the weighting factor determining unit 22 uses the attenuation coefficients αₙ, βₙ and γₙ determined by the attenuation coefficient determining unit 24 to determine the weighting factors sₙ, bₙ and hₙ, and the component image generating unit 23 uses the determined weighting factors sₙ, bₙ and hₙ to generate the component images Iₛ, I_{b} and Iₕ. Thus, the same effect as the first embodiment can be obtained.

In contrast to the weighting factor table 31 of the first embodiment associating the weighting factors for the three radiographic images (in the order of the low voltage, the medium voltage and the high voltage) with each combination of the component to be separated and the energy distribution information (in the order of the low voltage, the medium voltage and the high voltage) of the three radiographic images, the attenuation coefficient table 32 of this embodiment only associates the attenuation coefficients for the three components with each (one) energy distribution information (tube voltage) value, and therefore an amount of data to be registered in the table can significantly be reduced.

Similarly to the second embodiment, an image component separating device according to a fourth embodiment of the invention uses pixel values of pixels of one of the inputted three radiographic images as the parameter, and determines the above-described attenuation coefficients for each pixel based on this parameter, in order to reduce the effect of the beam hardening phenomenon which may occur in the third embodiment. Specifically, assuming that a pixel value of a pixel p in each inputted image Iₙ of each combination of the corresponding pixels is Iₙ(p), the thicknesses of the respective components are tₛ(p), t_{b}(p) and tₕ(p), and the image of the parameter pixels is I₁, the attenuation coefficients for the respective components to be separated are expressed as αₙ(I₁(p)), βₙ(I₁(p)) and γₙ(I₁(p)). Using these expressions, the pixel values I₁(p), I₂(p) and I₃(p) of the pixels p of the respective inputted images are expressed as the following equations (14), (15) and (16), respectively:

I₁(p)=α₁(I₁(p))·tₛ(p)+β₁(I₁(p))·t_{b}(p)+γ₁(I₁(p))·tₕ(p) (14),

I₂(p)=α₂(I₁(p))·tₛ(p)+β₂(I₁(p))·t_{b}(p)+γ₂(I₁(p))·tₕ(p) (15),

I₃(p)=α₃(I₁(p))·tₛ(p)+β₃(I₁(p))·t_{b}(p)+γ₃(I₁(p))·tₕ(p) (16).

Therefore, by substituting the terms αₙ, βₙ and γₙ in the above described equations (7), (8) and (9) with αₙ(I₁(p)), βn(I₁(p)) and γₙ(I₁(p)), the weighting factor for each pixel can be obtained and the component images can be generated in the similar manner to the second embodiment.

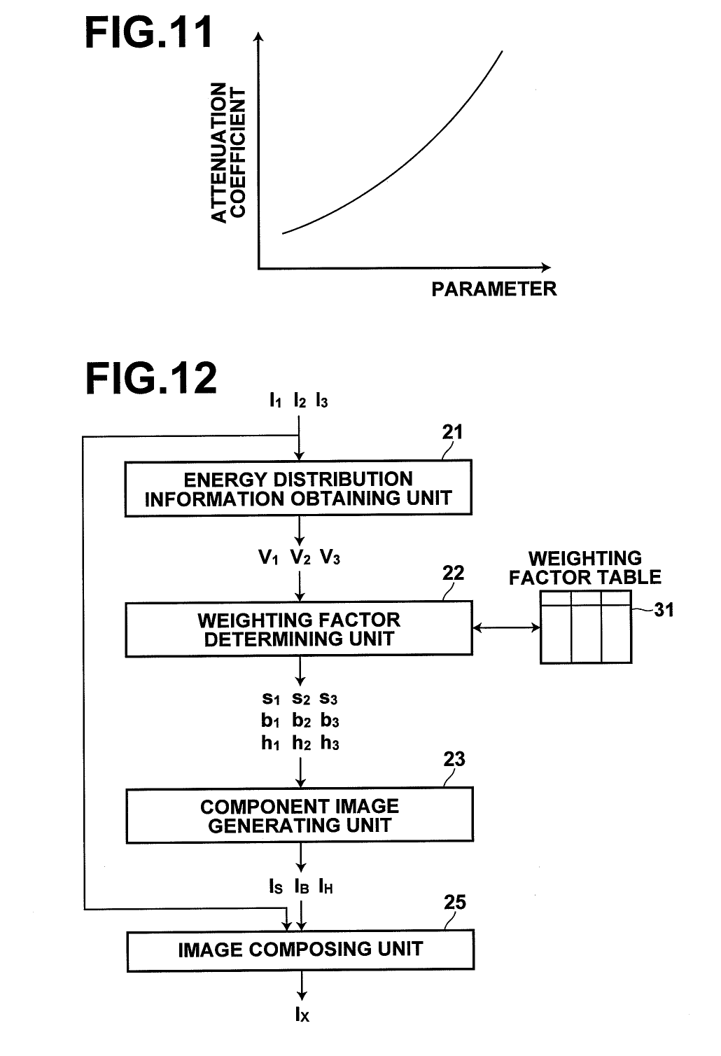

For implementation, relationships between the parameter I₁(p) and the respective attenuation coefficients αₙ(I₁(p)), βₙ(I₁(p)), γₙ(I₁(p)) (see FIG. 11) are found in advance through an experiment, and the resulting data is used for set the table. Specifically, similarly to the weighting factor table shown in FIG. 6, the item indicating ranges of pixel values of the parameter image I₁ is added to the attenuation coefficient table 32 shown in FIG. 9, so that an attenuation coefficient for each component at each pixel of each image can be set for each pixel value range of the corresponding pixels of the image I₁ and for each energy distribution information.

Along with the addition of the above-described item to the attenuation coefficient table 32, the attenuation coefficient determining unit 24 references the attenuation coefficient table 32 for each of the corresponding pixels of the three inputted images I₁, I₂ and I₃ with the energy distribution information of each image and the pixel value of the image I₁ used as the search key, to obtain attenuation coefficients for each of the corresponding pixels of the images, and the weighting factor determining unit 22 calculates the weighting factor for each pixel.

As described above, in the fourth embodiment of the invention, pixel values of the image I₁ are used as the parameter having a particular relationship with the thickness of each component to be separated, and the attenuation coefficient determining unit 24 determines the attenuation coefficients for each pixel based on this parameter. Thus, a factor reflecting the thickness of each component can be set for each pixel, thereby reducing the influence of the beam hardening phenomenon and achieving more appropriate separation between the components.

Although all of the soft part, bone and heavy element component images are generated in the above-described four embodiments, a user interface for receiving a selection of a component image wished to be generated may be provided. In this case, the weighting factor determining unit 22 determines only the weighting factors necessary for generating the selected component image, and the component image generating unit 23 generates only the selected component image.

An image component separating device according to a fifth embodiment of the invention has a function of generating a composite image by combining images selected by the imaging diagnostician, in addition to the functions of the image component separating device of any of the above-described four embodiments. FIG. 12 is a block diagram schematically illustrating the functional configuration and data flow of the image component separating device of this embodiment. As shown in the drawing, in this embodiment, an image composing unit 25 is added to the image component separating device of the first embodiment.

The image composing unit 25 includes a user interface for receiving a selection of two images to be combined, and a composite image generating unit for generating a composite image of the two images by calculating a weighted sum, using predetermined weighting factors, for each combination of corresponding pixels between the images to be combined. The corresponding pixels between the images are identified by aligning the images with each other in the same manner as the above-described component image generating unit 23. With respect to the predetermined weighting factors, appropriate weighting factors for possible combinations of images to be combined may be set in the default setting file of the system, so that the composite image generating unit may retrieve the weighting factors from the default setting file, or an interface for receiving weighting factors set by the user may be added to the user interface, so that the composite image generating unit uses the weighting factors set via the user interface.

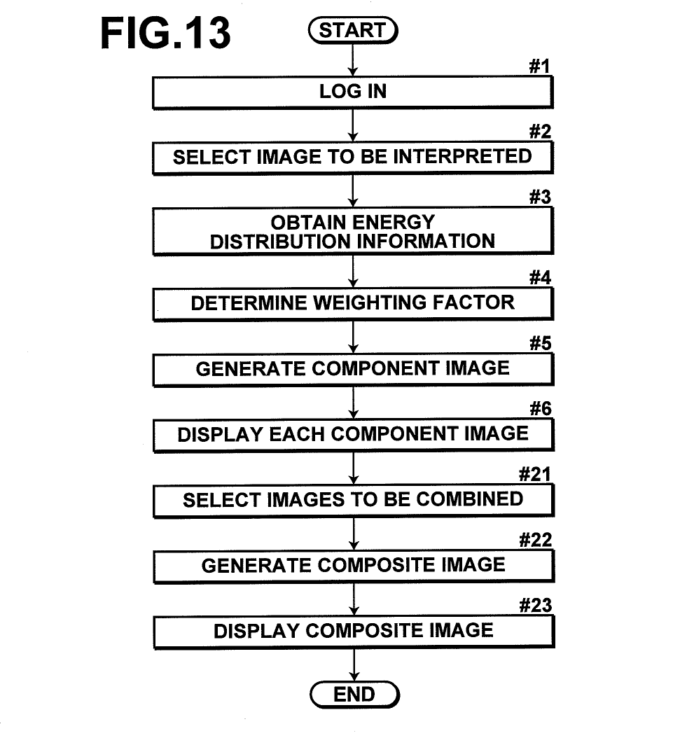

FIG. 13 is a flow chart illustrating the workflow of the image interpretation including the image separation process of this embodiment. As shown in the drawing, steps for generating a composite image is added after step #6 of the flow chart shown in FIG. 4.

Similarly to the first embodiment, the imaging diagnostician logs in the system (#1) and selects images to be interpreted (#2). With this operation, the program for implementing the image component separating device on the image interpretation workstation 3 is started.

Subsequently, the energy distribution information obtaining unit 21 obtains the tube voltages V₁, V₂ and V₃ of the images to be interpreted I₁, I₂ and I₃ (#3), and the weighting factor determining unit 22 references the weighting factor table 31 with the obtained tube voltage values V₁, V₂ and V₃ used as the search key to obtain weighting factors s₁, s₂, s₃, b₁, b₂, b₃, h₁, h₂ and h₃ for the respective components to be separated in the respective images (#4). The component image generating unit 23 calculates a weighted sum for each combination of corresponding pixels between the images with appropriately using the obtained weighting factors, to generate the soft part image Iₛ, the bone part image I_{b} and the heavy element image Iₕ (#5). The generated component images are displayed on the display monitor of the image interpretation workstation 3 (#6).

As the imaging diagnostician selects “Generate composite image” from the menu displayed on the display monitor of the image interpretation workstation 3 through the use of a mouse or the like, the image composing unit 25 displays on the display monitor a screen to prompt the user (the imaging diagnostician) to select images to be combined (#21). As a specific example of a user interface implemented on this screen for receiving the selection of the images to be combined, candidate images to be combined, such as the inputted images I₁, I₂ and I₃ and the component images Iₛ, I_{b} and Iₕ, may be displayed in the form of a list or thumbnails with checkboxes, so that the imaging diagnostician can click on and check the checkboxes corresponding to images which he or she wishes to combine.

As the imaging diagnostician has selected the images to be combined, the composite image generating unit of the image composing unit 25 calculates a weighted sum for each combination of the corresponding pixels between the images to be combined using the predetermined weighting factors, to generate a composite image Iₓ of these images (#22). The generated composite image Iₓ is displayed on the display monitor of the image interpretation workstation 3 and is used for image interpretation by the imaging diagnostician (#6).

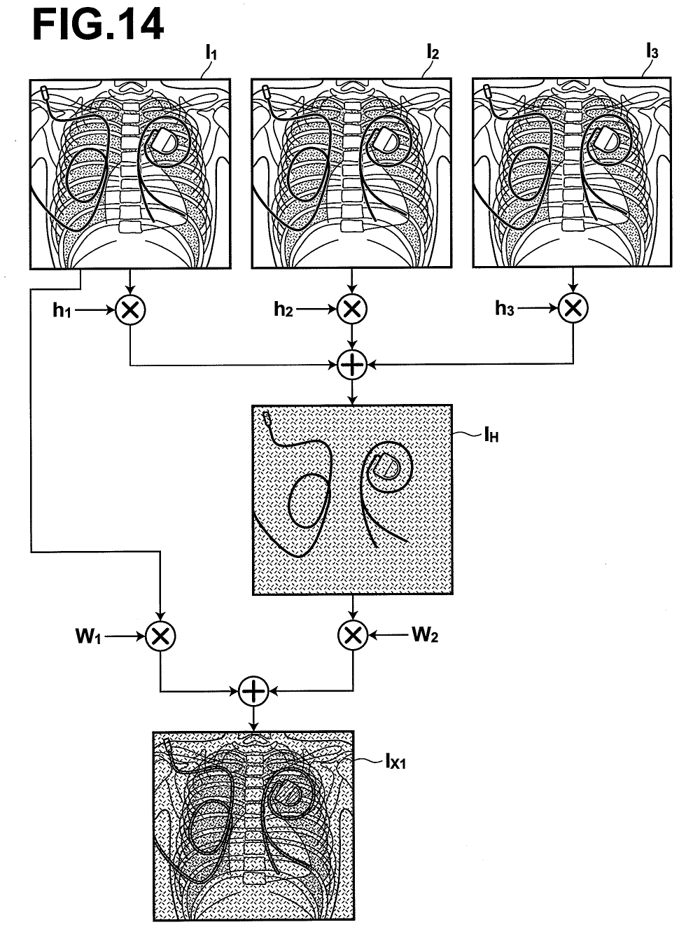

FIG. 14 schematically illustrates an image that may be generated when the inputted image I₁ and the heavy element image Iₕ are selected as the images to be combined. First, the component image generating unit 23 calculates a weighted sum expressed by h₁·I₁+h₂·I₂+h₃·I₃ for each combination of the corresponding pixels between the inputted images I₁, I₂ and I₃ to generate the heavy element image Iₕ from which the soft part component and the bone component have been removed. Next, the image composing unit 25 uses predetermined weighting factors w₁ and w₂ to calculate a weighted sum expressed by w₁·I₁+w₂·Iₕ for each combination of the corresponding pixels between the inputted image I₁ and the heavy element image Iₕ, to generate a composite image Iₓ₁ of the inputted image I₁ and the heavy element image Iₕ.

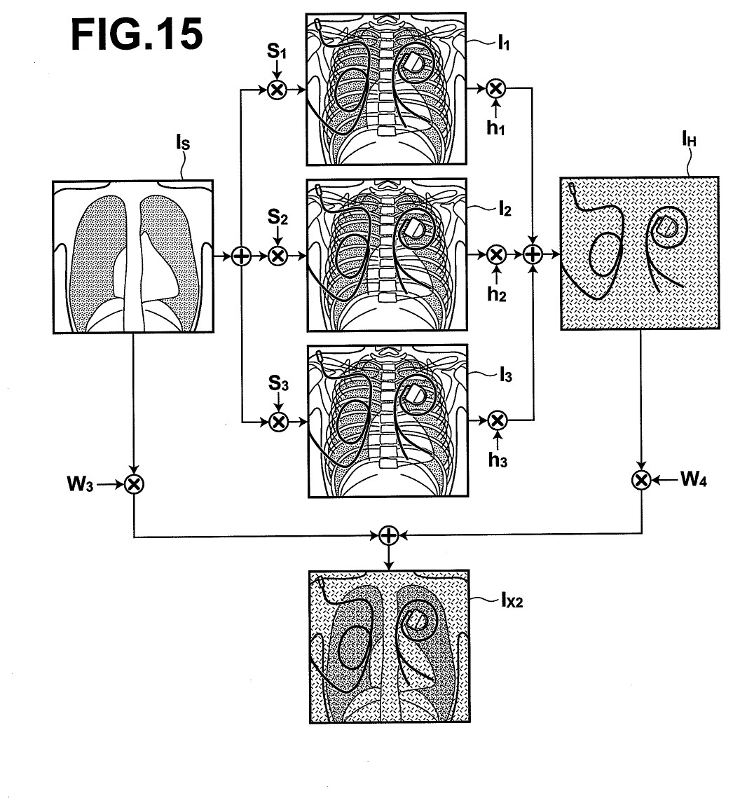

FIG. 15 schematically illustrates an image that may be generated when the soft part image Iₛ and the heavy element image Iₕ are selected as the images to be combined. First, the component image generating unit 23 calculates a weighted sum expressed by s₁·I₁+s₂·I₂+s₃·I₃ for each combination of the corresponding pixels between the inputted images I₁, I₂ and I₃ to generate the soft part image Iₛ from which the bone component and the heavy element component have been removed. Similarly, a weighted sum expressed by h₁·I₁+h₂·I₂+h₃·I₃ is calculated for each combination of the corresponding pixels to generate the heavy element image Iₕ from which the soft part component and the bone component have been removed. Next, the image composing unit 25 uses predetermined weighting factors w₃ and w₄ to calculate a weighted sum expressed by w₃·I₁+w₄·Iₕ for each combination of the corresponding pixels between the soft part image Iₛ and the heavy element image Iₕ, to generate a composite image Iₓ₂ of the soft part image Iₛ and the heavy element image Iₕ.

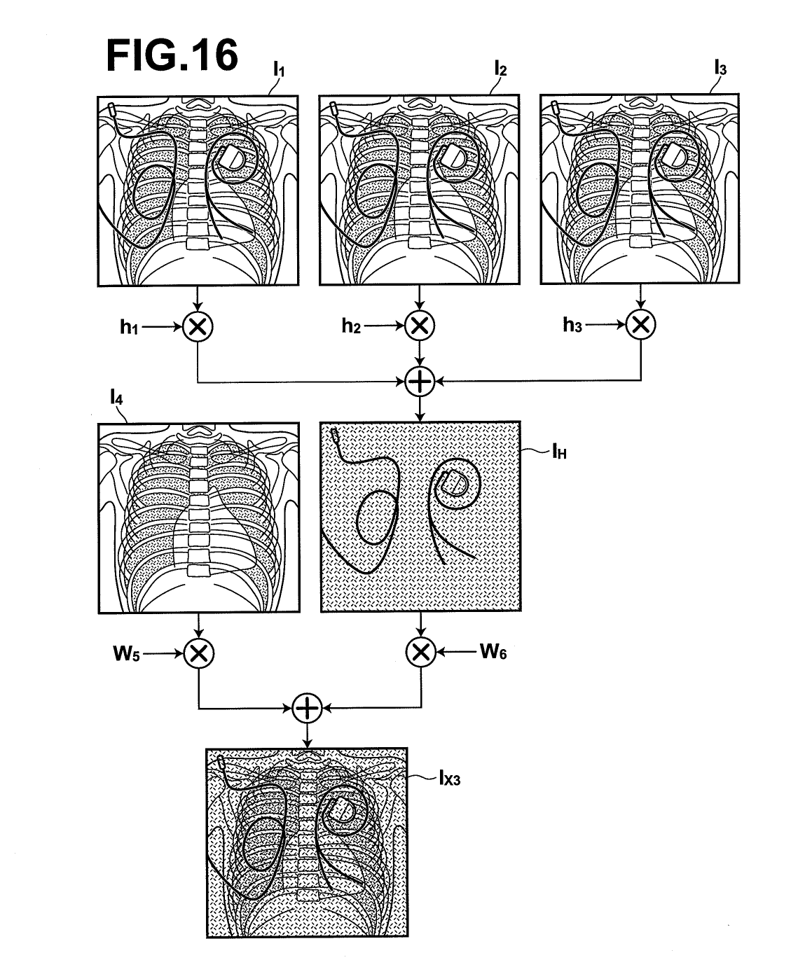

The images to be combined may include images other than the inputted images and the component images. As one example, FIG. 16 schematically illustrates an image that may be generated when a radiographic image I₄ of the same site of the subject as the inputted images and the heavy element image Iₕ are selected as the images to be combined. First, the component image generating unit 23 calculates a weighted sum expressed by h₁·I₁+h₂·I₂+h₃·I₃ for each combination of the corresponding pixels of the images I₁, I₂ and I₃ to generate the heavy element image Iₕ from which the soft part component and the bone component have been removed. Next, the image composing unit 25 uses predetermined weighting factors w₅ and w₆ to calculate a weighted sum expressed by w₅·I₁+w₆·Iₕ for each combination of the corresponding pixels of the image I₄ and the heavy element image Iₕ, to generate a composite image Iₓₛ of the inputted image I₄ and the heavy element image Iₕ.

As described above, in the fifth embodiment of the invention, the image composing unit 25 generates a composite image of a component image generated by the component image generating unit 23 and another image of the same subject, which are selected as the images to be combined, by calculating a weighted sum for each combination of the corresponding pixels of the images using the predetermined weighting factors. In this composite image, the image component contained in the component image, which has been separated from the inputted image, is enhanced, thereby improving visibility of the component in the image to be interpreted.

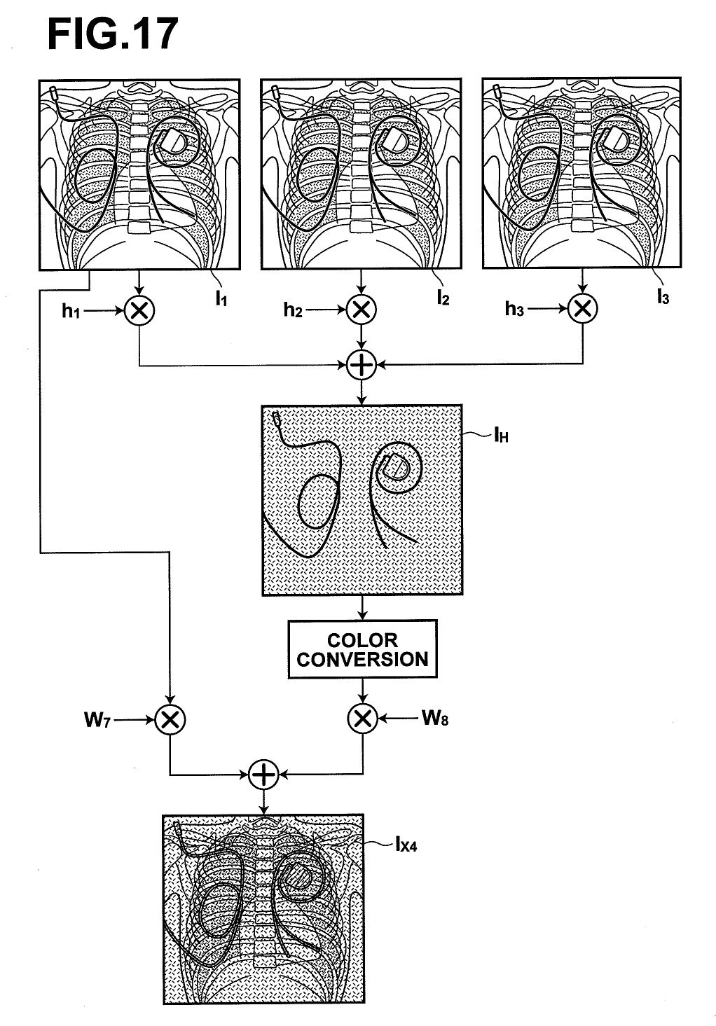

In the above-described embodiment, the color of the component image may be converted into a different color from the color of the other of the images to be combined before combining the images, as in an example shown in FIG. 17. In FIG. 17, the component image generating unit 23 calculates a weighted sum expressed by h₁·I₁+h₂·I₂+h₃·I₃ for each combination of the corresponding pixels between the inputted images I₁, I₂ and I₃ to generate the heavy element image Iₕ from which the soft part component and the bone component have been removed. Next, the image composing unit 25 converts the heavy element image Iₕ to assign pixel values of the heavy element image Iₕ to color difference component Cr in the YCrCb color space, and then, calculates a weighted sum expressed by w₇·I₁+w₈·Iₕ′ for each combination of the corresponding pixels between the inputted image I₁ and the converted heavy element image Iₕ′ to generate a composite image Iₓ₄ of the inputted image Iₓ₄ and the heavy element image Ih. Alternatively, the composite image Iₓ₄ may be generated after a conversion in which pixel values of the image I₁ are assigned to luminance component Y and pixel values of the heavy element image Iₕ are assigned to color difference component Cr in the YCrCb color space.

If the image composing unit 25 converts the color of the component image into a different color from the color of the other image before combining the images in this manner, visibility of the component is further improved.

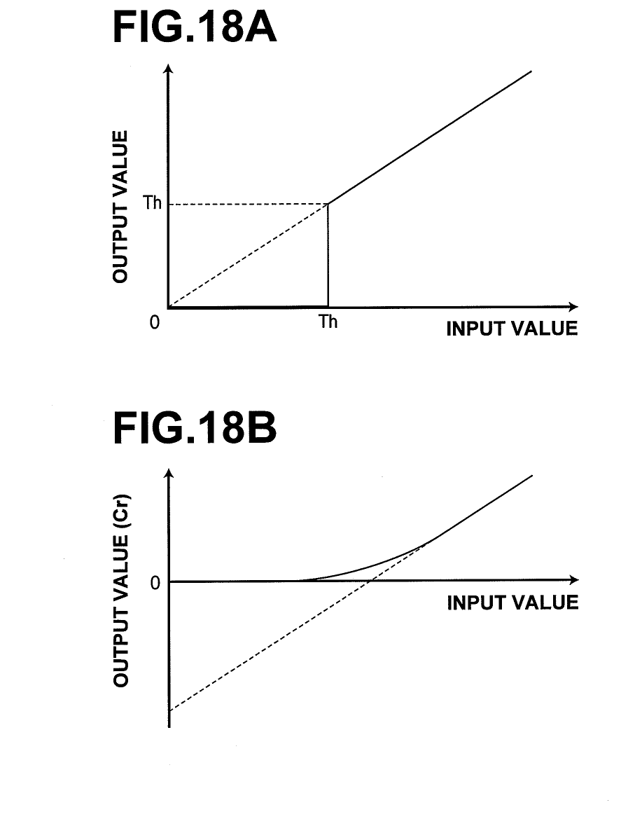

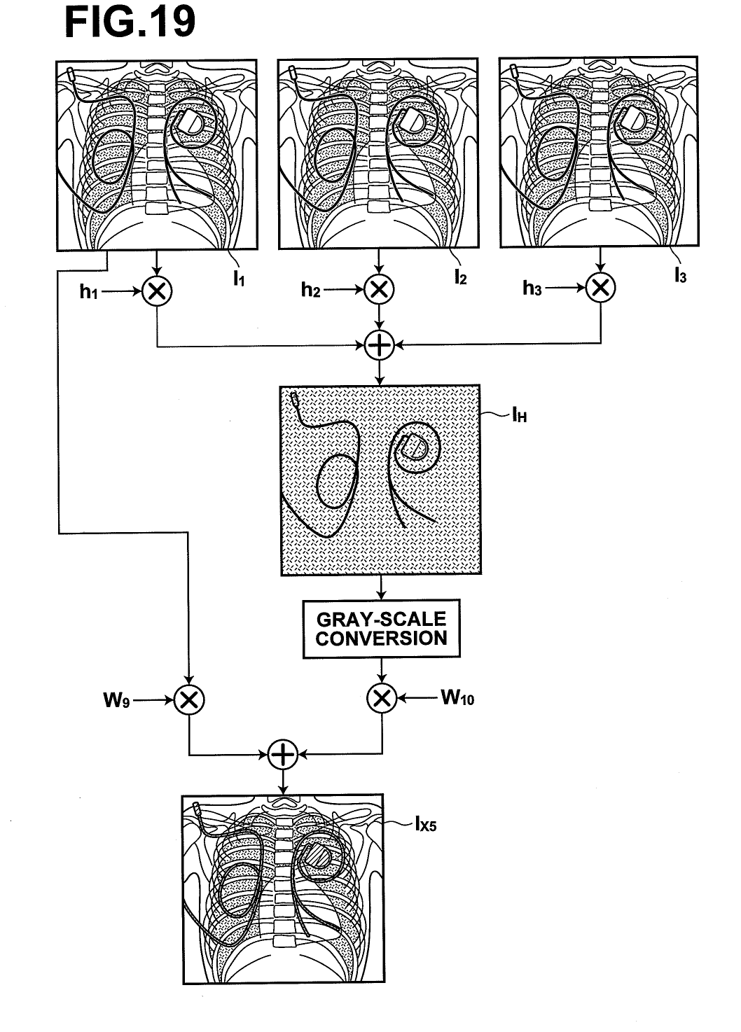

In a case where the component image contains many pixels having pixel values other than 0, the composite image is influenced by the pixel values of the component image such that the entire composite image appears grayish if the composite image is a gray-scale image, and the visibility may be lowered. Therefore, as shown in FIG. 18A, gray-scale conversion may be applied to the component image such that the value of 0 is outputted for pixels of the component image Iₕ having pixel values not more than a predetermined threshold, before combining the images. FIG. 19 schematically illustrates an image that may be generated in this case. First, the component image generating unit 23 calculates a weighted sum expressed by h₁·I₁+h₂·I₂+h₃·I₃ for each combination of the corresponding pixels between inputted images I₁, I₂ and I₃ to generate the heavy element image Iₕ from which the soft part component and the bone component have been removed. Next, the image composing unit 25 applies the above-described gray-scale conversion to the heavy element image Iₕ, and then, calculates a weighted sum expressed by w₉·I₁+w₁₀·Iₕ″ for each combination of the corresponding pixels between the inputted image I₁ and the converted heavy element image Iₕ″ to generate a composite image Iₓ₅ of the inputted image I₁ and the heavy element image Iₕ. In this composite image, only areas of the heavy element image Iₕ where the ratio of the heavy element component is high are enhanced, and visibility of the component is further improved.

Similarly, if a composite image obtained after the above-described color conversion contains many pixels having values of the color difference component other than 0, the composite image appears as an image tinged with the color according to the color difference component, and the visibility may be lowered. Further, if the color difference component has both positive and negative values, opposite colors appear in the composite image, and the visibility may further be lowered. Therefore, by applying gray-scale conversion to the component image Iₕ before combining the component image Iₕ and the image I₁, such that the value of 0 is outputted for the pixels of the component image Iₕ having values of the color difference component not more than a predetermined threshold, as shown in FIG. 18A for the former case and FIG. 18B for the latter case, a composite image is obtained in which only areas of the heavy element image Iₕ where the ratio of the heavy element component is high are enhanced, and the visibility of the component is further improved.

Although the image composing unit 25 in the example of the above-described embodiment combines two images, the image composing unit 25 may combine three or more images.

Although it is supposed in the above-described embodiments that there are multiple combinations of tube voltages of radiations of the inputted images, the energy distribution information obtaining unit 21 is not necessary if there is only one combination of the tube voltages of the three inputted images. In this case, the weighting factor determining unit 22 may not search the weighting factor table 21 for determination of the weighting factors, and may determine the weighting factors in a fixed manner based on a fixed coding of the program.

Similarly, the user interface included in the image composing unit 25 is not necessary if the imaging diagnostician is not allowed to select the images to be combined and the images to be combined are determined by the image composing unit 25 in a fixed manner, or if the image composition is carried out in a default image composition mode in which images to be combined are set in advance in the system, besides a mode for allowing the imaging diagnostician to select the images to be combined.

Further, the weighting factor table 31 and the attenuation coefficient table 32 may be implemented as functions (subroutines) having the same functional features.

According to the present invention, an image component representing any one of the soft part component, the bone component and the heavy element component in the subject is separated by calculating a weighted sum, using the predetermined weighting factors, for each combination of the corresponding pixels between the three radiographic images, which represent degrees of transmission through the subject of the radiations having the energy distributions of the three different patterns. This allows appropriate separation between the three components, thereby improving visibility of the image representing each component.

Further, by obtaining the energy distribution information of the radiation for each of the inputted radiographic images, and determining the weighting factors or the attenuation coefficients of the respective components based on the obtained energy distribution information, values of the factors and coefficients which are appropriate for the energy distribution information of the radiation of the inputted images can be obtained, thereby allowing more appropriate separation between the components.

Furthermore, by determining the weighting factors or the attenuation coefficients for each pixel based on the parameter obtained from at least one of the inputted three radiographic images, which have a particular relationship with the thicknesses of the respective components, the factors or coefficients reflecting the thicknesses of the respective components can be set for each pixel, thereby reducing the influence of the beam hardening phenomenon and allowing more appropriate separation between the components.

By combining a component image representing the component separated through the above-described process and another image (image to be combined) representing the same subject, an image containing the enhanced separated component can be obtained, thereby improving visibility of the separated component in the image to be interpreted.

Further, by converting the color of the separated component into a different color from the color of the other image to be combined before combining the images, visibility of the component is further improved.

Moreover, by applying gray-scale conversion before combining the images such that the value of 0 is assigned to pixels of the component image having pixel values smaller than a predetermined threshold, and combining the converted component image and the other image, an image can be obtained in which only areas of the component image where the ratio of the component contained is high are enhanced, and visibility of the component is further improved.

It is to be understood that many changes, variations and modifications may be made to the system configurations, the process flows, the table configurations, the user interfaces, and the like, disclosed in the above-described embodiments without departing from the spirit and scope of the invention, and such changes, variations and modifications are intended to be encompassed within the technical scope of the invention. The above-described embodiments are provided by way of examples, and should not be construed to limit the technical scope of the invention.

What is claimed is:

1. An image component separating device comprising a component separating means for separating an image component from inputted three radiographic images by calculating a weighted sum for each combination of corresponding pixels between the three radiographic images using predetermined weighting factors, wherein the three radiographic images are formed by radiation transmitted through a subject and represent degrees of transmission of three patterns of radiations having different energy distributions through the subject, and the image component is at least one of a soft part component, a bone component and a heavy element component including an element having an atomic number higher than that of the bone component in the subject.

2. The image component separating device as claimed in claim 1, wherein the component separating means obtains energy distribution information representing the energy distributions respectively corresponding to the three radiographic images, and determines the weighting factors based on the energy distribution information and the component to be separated.

3. The image component separating device as claimed in claim 1, wherein the component separating means determines the weighting factor for each pixel based on a parameter obtained from at least one of the three radiographic images, the parameter having a relationship with thicknesses of the respective components.

4. The image component separating device as claimed in claim 1, wherein the component separating means fits each of the radiographic images to a model representing an exposure amount of the radiation at each pixel position in the radiographic images as a sum of attenuation amounts of the radiation at the respective components and representing the attenuation amounts at the respective components by using attenuation coefficients determined for the respective components based on the energy distributions and thicknesses of the respective components, and determines the weighting factors such that the attenuation amounts at the components other than the component to be separated become small enough to meet a predetermined criterion.

5. The image component separating device as claimed in claim 4, wherein the component separating means obtains energy distribution information representing the energy distributions respectively corresponding to the three radiographic images, and determines the attenuation coefficients of the respective components based on the obtained energy distribution information.

6. The image component separating device as claimed in claim 4, wherein the component separating means determines, for each pixel, the attenuation coefficients of the respective components in each of the three radiographic images based on a parameter obtained from at least one of the three radiographic images and having a relationship with thicknesses of the respective components, such that the attenuation coefficient of each component monotonically decreases as the thicknesses of the components other than the component corresponding to the attenuation coefficient increase.

7. The image component separating device as claimed in claim 3, wherein the parameter comprises any of a logarithmic value of an amount of radiation at each pixel in one of the three radiographic images, a difference between logarithmic values of amounts of radiation at each combination of corresponding pixels in two of the three radiographic images, and a logarithmic value of a ratio of the amounts of radiation at said each combination of corresponding pixels.

8. The image component separating device as claimed in claim 6, wherein the parameter comprises any of a logarithmic value of an amount of radiation at each pixel in one of the three radiographic images, a difference between logarithmic values of amounts of radiation at each combination of corresponding pixels in two of the three radiographic images, and a logarithmic value of a ratio of amounts of radiation at said each combination of corresponding pixels.

9. The image component separating device as claimed in claim 1, further comprising image composing means for combining a component image representing the image component separated by the component separating means and another image representing the same subject by calculating a weighted sum for each combination of corresponding pixels between the images using predetermined weighting factors.

10. The image component separating device as claimed in claim 9, wherein the image composing means converts the color of the image component in the component image into a different color from the color of the other image before combining the images.

11. The image component separating device as claimed in claim 9, wherein the image composing means applies gray-scale conversion to the component image so that the value of 0 is assigned to pixels of the component image having pixel values smaller than a predetermined threshold, and combines the converted component image and the other image.

12. The image component separating device as claimed in claim 1, further comprising display means for displaying at least one of an image containing only the image component separated by the image component separating means and an image in which the image component is enhanced.

13. An image component separating method for separating an image component from inputted three radiographic images by calculating a weighted sum for each combination of corresponding pixels between the three radiographic images using predetermined weighting factors, wherein the three radiographic images are formed by radiation transmitted through a subject and represent degrees of transmission of three patterns of radiations having different energy distributions through the subject, and the image component is at least one of a soft part component, a bone component and a heavy element component including an element having an atomic number higher than that of the bone component in the subject.

14. A recording medium containing an image component separating program for causing a computer to carry out a process for separating an image component from inputted three radiographic images by calculating a weighted sum for each combination of corresponding pixels between the three radiographic images using predetermined weighting factors, wherein the three radiographic images are formed by radiation transmitted through a subject and represent degrees of transmission of three patterns of radiations having different energy distributions through the subject, and the image component is at least one of a soft part component, a bone component and a heavy element component including an element having an atomic number higher than that of the bone component in the subject.
